(19) United States
(12) Patent Application Publication
(10) Pub. No.: US 2012/0265478 A1
(43) Pub. Date: Oct. 18, 2012

(54) SYSTEMS AND METHODS FOR DETERMINING FRESHNESS OF LIVING CREATURES OBTAINED FROM SEA

(76) Inventor: TAI CHEUNG POON, Hong Kong (HK)

(21) Appl. No.: 13/088,374

(22) Filed: Apr. 17, 2011

(51) Int. Cl. G06F 15/00

(52) U.S. Cl. 702/131; 702/135

(57) ABSTRACT

Methods and systems for determining freshness of living creatures obtained from sea. In one embodiment, the present invention includes a container containing the living creatures, wherein the container has an outside surface that is transparent. The embodiment includes a non-contact infra-red thermometer placed outside the container used to detect body temperature of the living creatures from outside the container. In the embodiment, the system includes a camera physically attached to the thermometer, wherein the camera captures images of the living creatures in the container. Further, the system includes a set of rf readers and a set of rf emitters to detect the living creatures passing by.

### FIELD OF THE INVENTION

This invention generally relates to methods and systems determining freshness of living creatures obtained from sea. Specifically, but without any limitations, the invention includes initializing the seafood monitoring system, monitoring the living creatures, identifying certain events from happening, and taking actions after certain events have occurred.

### BACKGROUND OF THE INVENTION

Seafood is kept as inventory by restaurants or seafood dealers. One main challenge for restaurants or seafood dealers is to decide the lifespan of the seafood purchased. If the purchased seafood is going to die in a short amount of time, the owners of the restaurants and the dealers would be eager to sell the seafood quicker by reducing the prices of the seafood, as the prices of the seafood would go down significantly once the seafood becomes stale. On the other hand, if the purchased seafood can last longer, the restaurant owners and dealers may feel more comfortable to hold on to the seafood to wait for the right buyers without hurrying to give discounts.

In view of the foregoing, there is a need to monitor the health of seafood held in inventory, especially if the seafood is expensive. There is a need to identify any living creatures that are dying; identify the living creatures that worth most money; identify the living creatures that worth least amount of money; and identify the living creatures with broken scales, which implicates being infected with a disease. Further, if monitoring of the seafood can be done continuously, there is a greater chance to predict when certain seafood should be sold, before it is too late, in order to maximize profits.

### SUMMARY OF THE INVENTION

A cargo alert system is provided for preventing cargo goods from stolen. According to an embodiment of the invention, a system is provided, A seafood monitoring system is provided for determining freshness of living creatures obtained from sea. According to an embodiment of the invention, a system is provided, comprising a container containing the living creatures, wherein the container has an outside surface that is transparent.

Consistent with embodiments of the invention, the system may include a non-contact infra-red thermometer placed outside the container used to detect body temperature of the living creatures from outside the container. A camera may further be physically attached to the thermometer, wherein the camera captures images of the living creatures in the container,

A set of rf readers may be included. In one embodiment, each rf reader is placed on the outside surface of the container to detect the living creatures passing by; a set of rf emitters, where each of the rf emitters is associated with each of the living creatures to allow detection by the rf readers.

Further, a processor may be included in the container, and a memory may be coupled in the container, wherein the memory store instructions executable by the processor, the instructions including initializing the seafood monitoring system; monitoring the living creatures, wherein the monitoring is configured to monitor a living creature continuously through a plurality of parameters.

The container in this instance may contain one species only, the monitored parameters including body temperature of the living creature that implicates how active the living creature has become, by using the non-contact infra-red thermometer; eye color changes of the living creature, by using the camera physically attached to the thermometer; changes of fin movement that implicates level of freshness of the living creature, by using the set of rf readers and rf emitters (200); changes of fin color that implicates level of freshness of the living creature, by using the camera physically attached to the thermometer; and scale color changes that implicates level of freshness of the living creature, by using the camera physically attached to the thermometer; monitor collectively a certain species of living creatures in the container, wherein the container in this instance contains one species only; and monitor a plurality of living creatures, wherein each monitored living creature is a representative of its own species of living creatures in the container, the container in this instance containing multiple species; identifying whether certain events has happened; and taking actions after the certain events have occurred.

### BRIEF DESCRIPTION OF THE DRAWINGS

FIG. 1 illustrates an exemplary system for determining freshness of living creatures obtained from sea.

### DETAILED DESCRIPTION

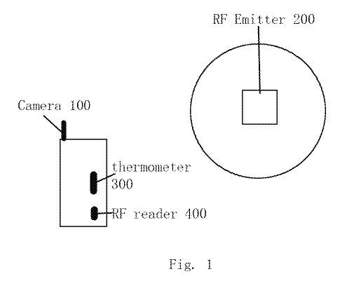

Systems and methods are provided for determining freshness of living creatures obtained from sea. Referring to FIG. 1, an embodiment of the inventions include a seafood monitoring system, comprising a container containing the living creatures, wherein the container has an outside surface that is transparent; a non-contact infra-red thermometer (300) placed outside the container used to detect body temperature of the living creatures from outside the container; a camera (100) physically attached to the thermometer.

The camera (100) may be configured to capture images of the living creatures in the container; a set of rf readers (400), where each rf reader is placed on the outside surface of the container to detect the living creatures passing by; a set of if emitters (200), where each of the rf emitters (200) is associated with each of the living creatures to allow detection by the rf readers (400); a processor included in the container; and a memory included in the container, wherein the memory store instructions executable by the processor, the instructions including initializing the seafood monitoring system; monitoring the living creatures, wherein the monitoring is configured to monitor a living creature continuously through a plurality of parameters, wherein the container in this instance contains one species only, the monitored parameters including body temperature of the living creature that implicates how active the living creature has become, by using the non-contact infra-red thermometer; eye color changes of the living creature, by using the camera (100) physically attached to the thermometer; changes of fin movement that implicates level of freshness of the living creature, by using the set of rf readers (400) and rf emitters (200); changes of fin color that implicates level of freshness of the living creature, by using the camera (100) physically attached to the thermometer; and scale color changes that implicates level of freshness of the living creature, by using the camera (100) physically attached to the thermometer, monitor collectively a certain species of living creatures in the container.

The container may contain multiple species. In this instance contains one species only; and monitor a plurality of living creatures, wherein each monitored living creature is a representative of its own species of living creatures in the container, the container in this instance containing multiple species; identifying whether certain events has happened; and taking actions after the certain events have occurred.

As an another example, the seafood monitoring system for determining freshness of living creatures obtained from sea, comprising a container containing the living creatures, wherein the container has an outside surface that is transparent; a non-contact infra-red thermometer (300) placed outside the container used to detect body temperature of the living creatures from outside the container; a camera (100) physically attached to the thermometer, wherein the camera (100) captures images of the living creatures in the container; a set of rf readers (400), where each rf reader is placed on the outside surface of the container to detect the living creatures passing by; a set of rf emitters (200), where each of the rf emitters (200) is associated with each of the living creatures to allow detection by the rf readers (400); a processor included in the container; and a memory included in the container, wherein the memory store instructions executable by the processor, the instructions including initializing the seafood monitoring system; monitoring the living creatures, wherein the monitoring is configured to monitor a living creature continuously through a plurality of parameters, wherein the container in this instance contains one species only, the monitored parameters including body temperature of the living creature that implicates how active the living creature has become, by using the non-contact infra-red thermometer; eye color changes of the living creature, by using the camera (100) physically attached to the thermometer; changes of fin movement that implicates level of freshness of the living creature, by using the set of rf readers (400) and rf emitters (200); changes of fin color that implicates level of freshness of the living creature, by using the camera (100) physically attached to the thermometer; and scale color changes that implicates level of freshness of the living creature, by using the camera (100) physically attached to the thermometer; monitor collectively a certain species of living creatures in the container, wherein the container in this instance contains one species only; and monitor a plurality of living creatures, wherein each monitored living creature is a representative of its own species of living creatures in the container, the container in this instance containing multiple species; identifying whether certain events have occurred, of which the occurrence of the events indicates that a drop of freshness has occurred, wherein the living creature's body temperature of the living creature has dropped; the eye color of the living creature has become lighter; the degree of the fin movement of the living creature has dropped; the fin color of the living creature has become lighter; and the scale color of the living creature has become lighter; and taking actions after the certain events have occurred.

The instructions executed by the processor may alternatively include initializing the seafood monitoring system; monitoring the living creatures, wherein the monitoring is configured to monitor a living creature continuously through a plurality of parameters, wherein the container in this instance contains one species only, the monitored parameters including body temperature of the living creature that implicates how active the living creature has become, by using the non-contact infra-red thermometer; eye color changes of the living creature, by using the camera (100) physically attached to the thermometer; changes of fin movement that implicates level of freshness of the living creature, by using the set of rf readers (400) and rf emitters (200); changes of fin color that implicates level of freshness of the living creature, by using the camera (100) physically attached to the thermometer; and scale color changes that implicates level of freshness of the living creature, by using the camera (100) physically attached to the thermometer, monitor collectively a certain species of living creatures in the container, wherein the container in this instance contains one species only; and monitor a plurality of living creatures, wherein each monitored living creature is a representative of its own species of living creatures in the container, the container in this instance containing multiple species; identifying whether certain events have occurred, of which the occurrence of the events indicates that a drop of freshness has occurred, wherein the living creature's body temperature of the living creature has dropped; the eye color of the living creature has become lighter; the degree of the fin movement of the living creature has dropped; the fin color of the living creature has become lighter; and the scale color of the living creature has become lighter; and taking actions after the certain events have occurred, wherein the actions include reducing prices of the living creature by giving a discount.

Further, the exemplary instructions may include monitoring the living creatures, wherein the monitoring is configured to monitor a living creature continuously through a plurality of parameters, wherein the container in this instance contains one species only, the monitored parameters including body temperature of the living creature that implicates how active the living creature has become, by using the non-contact infra-red thermometer; eye color changes of the living creature, by using the camera (100) physically attached to the thermometer; changes of fin movement that implicates level of freshness of the living creature, by using the set of rf readers (400) and rf emitters (200); changes of fin color that implicates level of freshness of the living creature, by using the camera (100) physically attached to the thermometer; and scale color changes that implicates level of freshness of the living creature, by using the camera (100) physically attached to the thermometer; monitor collectively a certain species of living creatures in the container, wherein the container in this instance contains one species only, in order to identify any living creatures that are dying; identify the living creatures that worth most money; identify the living creatures that worth least amount of money; identify the living creatures with broken scales, which implicates being infected with a disease; and monitor a plurality of living creatures, wherein each monitored living creature is a representative of its own species of living creatures in the container, the container in this instance containing multiple species; identifying whether certain events have occurred, of which the occurrence of the events indicates that a drop of freshness has occurred, wherein the living creature's body temperature of the living creature has dropped; the eye color of the living creature has become lighter; the degree of the fin movement of the living creature has been dropped; the fin color of the living creature has become lighter; and the scale color of the living creature has become lighter; and taking actions after the certain events have occurred, wherein the actions include reducing prices of the living creature by giving a discount.

What is claimed is:

1. A seafood monitoring system for determining freshness of living creatures obtained from sea, comprising:
a container containing the living creatures, wherein the container has an outside surface that is transparent;
a non-contact infra-red thermometer placed outside the container used to detect body temperature of the living creatures from outside the container;
a camera physically attached to the thermometer, wherein the camera captures images of the living creatures in the container;
a set of rf readers, where each rf reader is placed on the outside surface of the container to detect the living creatures passing by;
a set of rf emitters, where each of the rf emitters is associated with each of the living creatures to allow detection by the rf readers;
a processor included in the container; and
a memory included in the container, wherein the memory store instructions executable by the processor.

2. The system of claim 1, wherein the instructions further comprise:
initializing the seafood monitoring system;
monitoring the living creatures, wherein the monitoring is configured to:
monitor a living creature continuously through a plurality of parameters, wherein the container in this instance contains one species only, the monitored parameters including:
body temperature of the living creature that implicates how active the living creature has become, by using the non-contact infra-red thermometer;
eye color changes of the living creature, by using the camera physically attached to the thermometer;
changes of fin movement that implicates level of freshness of the living creature, by using the set of rf readers and rf emitters;
changes of fin color that implicates level of freshness of the living creature, by using the camera physically attached to the thermometer; and
scale color changes that implicates level of freshness of the living creature, by using the camera physically attached to the thermometer;
monitor collectively a certain species of living creatures in the container, wherein the container in this instance contains one species only; and
monitor a plurality of living creatures, wherein each monitored living creature is a representative of its own species of living creatures in the container, the container in this instance containing multiple species;
identifying whether certain events has happened; and
taking actions after the certain events have occurred.

3. The system of claim 1, wherein the instructions further comprise:
initializing the seafood monitoring system;
monitoring the living creatures, wherein the monitoring is configured to:
monitor a living creature continuously through a plurality of parameters, wherein the container in this instance contains one species only, the monitored parameters including:
body temperature of the living creature that implicates how active the living creature has become, by using the non-contact infra-red thermometer;
eye color changes of the living creature, by using the camera physically attached to the thermometer;
changes of fin movement that implicates level of freshness of the living creature, by using the set of rf readers and rf emitters;
changes of fin color that implicates level of freshness of the living creature, by using the camera physically attached to the thermometer; and
scale color changes that implicates level of freshness of the living creature, by using the camera physically attached to the thermometer;
monitor collectively a certain species of living creatures in the container, wherein the container in this instance contains one species only; and
monitor a plurality of living creatures, wherein each monitored living creature is a representative of its own species of living creatures in the container, the container in this instance containing multiple species;
identifying whether certain events have occurred, of which the occurrence of the events indicates that a drop of freshness has occurred, wherein:
the living creature's body temperature of the living creature has dropped;
the eye color of the living creature has become lighter;
the degree of the fin movement of the living creature has dropped;
the fin color of the living creature has become lighter; and
the scale color of the living creature has become lighter; and
taking actions after the certain events have occurred.

4. The system of claim 1, wherein the instructions further comprise:
initializing the seafood monitoring system;
monitoring the living creatures, wherein the monitoring is configured to:
monitor a living creature continuously through a plurality of parameters, wherein the container in this instance contains one species only, the monitored parameters including:
body temperature of the living creature that implicates how active the living creature has become, by using the non-contact infra-red thermometer;
eye color changes of the living creature, by using the camera physically attached to the thermometer;
changes of fin movement that implicates level of freshness of the living creature, by using the set of rf readers and rf emitters;
changes of fin color that implicates level of freshness of the living creature, by using the camera physically attached to the thermometer; and
scale color changes that implicates level of freshness of the living creature, by using the camera physically attached to the thermometer;
monitor collectively a certain species of living creatures in the container, wherein the container in this instance contains one species only; and
monitor a plurality of living creatures, wherein each monitored living creature is a representative of its own species of living creatures in the container, the container in this instance containing multiple species;
identifying whether certain events have occurred, of which the occurrence of the events indicates that a drop of freshness has occurred, wherein:
the living creature's body temperature of the living creature has dropped;
the eye color of the living creature has become lighter;
the degree of the fin movement of the living creature has dropped;
the fin color of the living creature has become lighter; and
the scale color of the living creature has become lighter; and
taking actions after the certain events have occurred, wherein the actions include reducing prices of the living creature by giving a discount.

5. The system of claim 1, wherein the instructions further comprise:
initializing the seafood monitoring system;
monitoring the living creatures, wherein the monitoring is configured to:
monitor a living creature continuously through a plurality of parameters, wherein the container in this instance contains one species only, the monitored parameters including:
body temperature of the living creature that implicates how active the living creature has become, by using the non-contact infra-red thermometer;
eye color changes of the living creature, by using the camera physically attached to the thermometer;
changes of fin movement that implicates level of freshness of the living creature, by using the set of rf readers and rf emitters;
changes of fin color that implicates level of freshness of the living creature, by using the camera physically attached to the thermometer; and
scale color changes that implicates level of freshness of the living creature, by using the camera physically attached to the thermometer;
monitor collectively a certain species of living creatures in the container, wherein the container in this instance contains one species only, in order to:
identify any living creatures that are dying;
identify the living creatures that worth most money;
identify the living creatures that worth least amount of money;
identify the living creatures with broken scales, which implicates being infected with a disease; and
monitor a plurality of living creatures, wherein each monitored living creature is a representative of its own species of living creatures in the container, the container in this instance containing multiple species;
identifying whether certain events have occurred, of which the occurrence of the events indicates that a drop of freshness has occurred, wherein:
the living creature's body temperature of the living creature has dropped;
the eye color of the living creature has become lighter;
the degree of the fin movement of the living creature has been dropped;
the fin color of the living creature has become lighter, and
the scale color of the living creature has become lighter; and
taking actions after the certain events have occurred, wherein the actions include reducing prices of the living creature by giving a discount.
